(19) United States
(12) Patent Application Publication
(10) Pub. No.: US 2006/0208449 A1
(43) Pub. Date: Sep. 21, 2006

(54) AUTOMOTIVE RUNNING BOARD

(75) Inventors: James Kuo, Farmington Hills, MI (US); Mark McChesney, Saline, MI (US); Patrick Schiavone, Birmingham, MI (US); Chelsia Lau, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 10/906,979

(22) Filed: Mar. 15, 2005

(51) Int. Cl. B60R 3/00

(52) U.S. Cl. 280/163

(57) ABSTRACT

A vehicle having a running board provided substantially beneath a vehicle door, which is accessible when the vehicle door is in an open orientation is disclosed.

### BACKGROUND OF THE INVENTION

1. Field of the Invention

The present invention relates to exterior features for passenger vehicles, and more specifically, to automotive running boards.

2. Background Art

Passenger vehicles that facilitate transportation of multiple passengers have been popular for many years. Utility vehicles such as sport utility vehicles and pickup trucks have also been popular for many years. As utility vehicles have become popular for utilization as passenger vehicles, manufacturers of utility vehicles have incorporated many features into utility vehicles to enhance passenger transportation and comfort.

Utility vehicles are generally designed for hauling cargo, whether in a cargo compartment, a bed of the vehicle, or in tow. Utility vehicles are also often designed for travel through rough terrain. In order to meet these design objectives, utility vehicles are often provided with a vehicle body that is elevated greater than conventional passenger vehicles. For example, utility vehicles often have a passenger compartment that is provided at a greater height than the passenger compartments for conventional passenger vehicles such as sedans or minivans.

In order to market utility vehicles to consumers of varying physical characteristics, running boards have been provided as an option to utility vehicles. A running board is often embodied as an external step provided on the motor vehicle body to assist a user in entering and exiting the passenger compartment. Rather than requiring the passenger to step directly into the passenger compartment, the passenger may first step on the running board and then step into the passenger compartment.

The prior art has provided running boards that extend laterally from the vehicle body to facilitate ingress and egress to and from the passenger compartment. However, prior art running boards often detract from the external ornamental appearance of the passenger vehicle.

Additionally, prior art running boards often collect dirt, mud, dust or other substances since the running board protrudes outward from the vehicle body. As a passenger egresses the vehicle, the passenger's pant leg may become soiled if it contacts the outward extending running board. Although prior art running boards assist in passengers entering the vehicle compartment, they often provide such difficulties in exiting the vehicle.

Accordingly, the prior art has offered a retractable running board that extends laterally from the vehicle for use and is retracted towards the vehicle body when not in use. This proposal may reduce the amount of dirt, mud, etc. collected, although it is a mechanically complex alternative.

In view of the foregoing, a simplified running board is needed that optimizes compactness, utility, style, footing and passenger assistance.

### SUMMARY OF THE INVENTION

An aspect of the present invention is to provide a passenger vehicle having a vehicle body, a passenger compartment, a door frame in the vehicle body, a door aperture through the door frame, a door mounted to the door frame, and a running board mounted to the vehicle body. The running board is oriented substantially beneath the door in the closed orientation of the door and supports a foot of a passenger in the open orientation of the door.

Another aspect of the present invention is to provide a running board for a motor vehicle having ends that are affixable to the vehicle body. The running board includes a platform extending between the ends that is displaced beneath and proximate to a lower region of a door of the motor vehicle. The platform is accessible in an open orientation of the door and inaccessible in a closed orientation of the door.

A further aspect of the present invention is to provide a running board that is disposed at a height with respect to the door frame such that a bottom portion of the door is oriented adjacent to the running board when closed.

Another non-limiting aspect of the present invention is to provide the running board oriented proximate to the door frame and spaced apart from the door frame for providing clearance for the passenger's foot.

A further aspect of the present invention is to orient a running board inboard with respect to a lower region of the door beneath a belt line of the vehicle.

Yet another non-limiting aspect of the present invention is to dispose the running board inboard of a lower region of the door that is within six inches from the running board.

A further aspect of the present invention is a running board which does not extend laterally outboard from the vehicle greater than a similar dimension of the door when closed.

Another aspect of the invention is to integrate the running board and a front quarter panel and a rear quarter panel of the vehicle.

A further aspect is to provide the running board partially beneath the door frame.

An aspect of the present invention is to provide the running board with a generally planar top surface and traction that is provided by a series of traction pads extending from the running board.

A further aspect is wherein an interior floor includes a pattern of traction pads corresponding to traction pads provided on the running board.

Yet another aspect is wherein a plurality of tires each include a pattern of traction pads to match to those provided upon the running board.

A further aspect is a running board having a top surface extending partially beneath the door frame.

Another aspect of the present invention is a running board at least partially inaccessible when the door is closed.

An additional aspect of the present invention is a running board fixed relative to the vehicle body.

Another aspect of the present invention includes a second door frame formed within the vehicle body adjacent to the first door frame.

Another aspect is to provide a second door aperture through the vehicle body.

Yet another aspect is to provide a second door connected to the second door frame.

An aspect of the present invention is a pair of doors each pivotally connected to the vehicle body, each about a generally vertical pivot axis.

An aspect of the present invention includes a vehicle body pillar between the first door frame and the second door frame.

The above aspects, and other aspects, objects, features, advantages, embodiments and benefits of the present invention are readily apparent from the detailed description of embodiments of the invention when taken in connection with the accompanying drawings.

### BRIEF DESCRIPTION OF THE DRAWINGS

FIG. 1 is a perspective view of a passenger vehicle in accordance with the teachings of the present invention;

FIG. 2 is a side perspective view of the passenger vehicle of FIG. 1;

FIG. 3 is a side perspective view of the passenger vehicle of FIG. 1, illustrated with a door thereof in an open orientation, revealing a running board in accordance with the present invention; and

FIG. 4 is a fragmentary section view of the vehicle door and the running board taken along section line 4-4 of FIG. 2.

### DETAILED DESCRIPTION OF EMBODIMENTS OF THE INVENTION

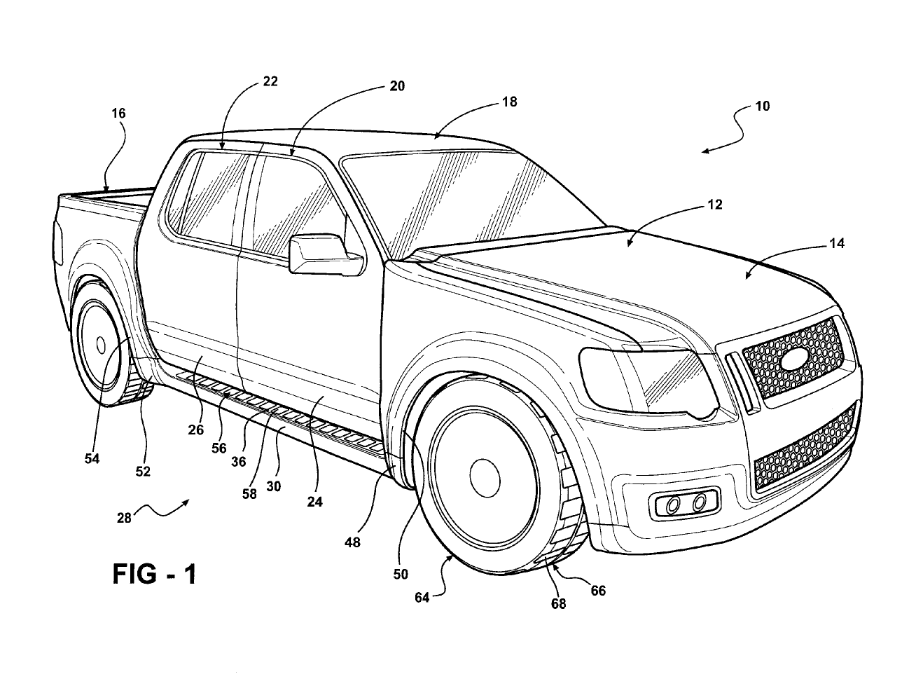

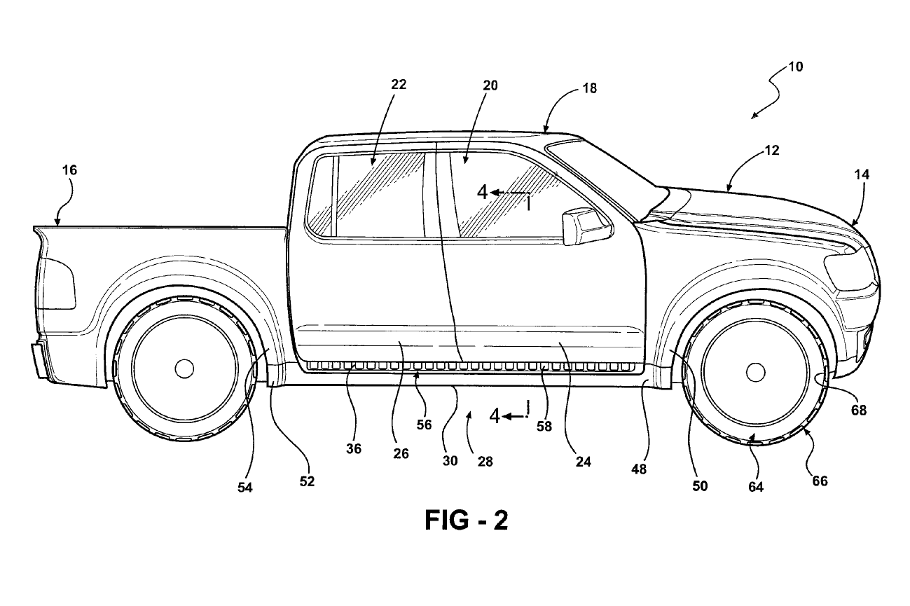

With reference now to FIGS. 1 and 2, a passenger vehicle is illustrated in accordance with the teachings of the present invention. The passenger vehicle is referenced by numeral 10 and is illustrated as an extended cab pickup truck. However, the invention contemplates any passenger vehicle within the spirit and scope of the present invention.

The passenger vehicle 10 includes a vehicle body 12. The vehicle body 12 includes a front end 14, a rear end 16 with a passenger compartment 18 provided therebetween. Since the exemplary passenger vehicle 10 is illustrated as a pickup truck, a rear end 16 includes a bed for transporting cargo.

The passenger compartment 18 of the exemplary embodiment includes two rows for passenger seating, namely a front row 20 and a back row 22. The front row 20 and the back row 22 each include a pair of doors on opposed lateral sides of the vehicle 10, such as front side door 24 and back side door 26 illustrated in FIGS. 1 and 2. The side doors 24, 26 are illustrated on a right side 28 of the vehicle 10. Although the doors for the left side of the vehicle are not illustrated, the left side doors may generally be a mirror image of the right side doors 24, 26 because the body 12 of the vehicle 10 may be generally symmetrical.

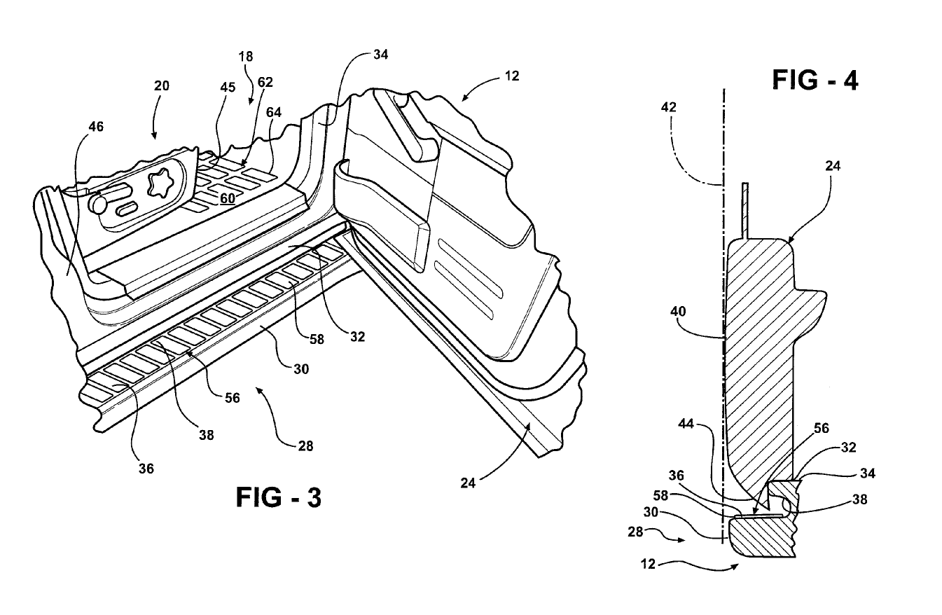

The side doors 24, 26 are illustrated in a closed orientation in FIGS. 1 and 2. Both doors 24, 26 may be translated to an open orientation. Referring now to FIG. 3, an exemplary open orientation is illustrated for the front side door 24. For the passenger vehicle 10 of the present invention, all four side doors open in the manner illustrated in FIG. 3, by pivoting about a vertical axis through a hinged connection. Of course, any open orientation is contemplated within the spirit and scope of the present invention. For example, one of the doors could open by translating along a longitudinal track on a side of the vehicle body 12.

Referring again to FIGS. 1 and 2, the passenger compartment 18 is generally elevated relative to an underlying support surface upon which the vehicle 10 travels. Therefore, to facilitate ingress and egress of passengers of varying physical characteristics, it may be desirable to provide a step assist that may be utilized by passengers by placement of a foot or feet and temporarily supporting the load of the passenger. Accordingly, a running board 30 may be provided on each lateral side of the vehicle body 12 for temporarily supporting the passenger while entering or exiting the compartment 18.

Referring again to FIG. 3, a door frame 32 is formed to the vehicle body 12 beneath each door 24, 26. Each door frame 32 provides a door aperture 34 through the vehicle body 12 so that the passenger may pass therethrough when the corresponding door, such as front side door 24 is in the open orientation.

In order to provide a compact and streamlined passenger step, the running board 30 is displaced beneath the side doors 24, 26. As illustrated in FIG. 3, each running board 30 includes a generally planar platform 36 for receiving a foot or feet of the passenger. Additionally, the platform 36 includes traction for enhancing friction therebetween and providing sound footing to the passenger when stepping upon the running board 30.

As illustrated in FIG. 3, the platform 36 of the running board 30 is accessible to the passenger when the door, such as front side door 24, is in the open orientation. To facilitate compactness, the platform 36 extends laterally inward beneath the door frame 32. Referring now to FIG. 4, a portion of the vehicle body 12 is illustrated in partial section including the front side door 24, the door frame 32 and the running board 30. These vehicle body components are illustrated as solid sections to simplify components that are ordinarily retained within their cross section. The section view of FIG. 4 is provided to merely illustrate the cooperation of the door frame 32, running board 30 and a door, such as front side door 24.

As the platform 36 extends beneath the door frame 32, a recess 38 is provided beneath the door frame 32 for providing clearance for the passenger's foot as the passenger steps upon the running board 30. Thus, the running board 30 adequately assists passengers while entering and exiting the passenger compartment 18. For compactness, the running board platform 36 is oriented proximate to the underside of the door frame 32. For example, a maximum height dimension of the recess 38 may be four inches.

Referring to FIGS. 3 and 4, the running board 30 is generally compact in comparison to prior art running boards. For example, the running board 30 extends laterally outward from the vehicle body 12 proximately a similar distance to an outwardmost surface on an exterior contour 40 of the front side door 24. Thus, when exiting the vehicle, if a passenger desires not to utilize the running board 30, the passenger may easily avoid contact with the running board 30. This dimensional arrangement helps prevent the passenger from rubbing a pant leg along the side of the running board 30, which may have collected dirt or dust during travel.

Additionally, the compactness of the running board 30 promotes the external aesthetics of the passenger vehicle 10. Referring to FIG. 4, an imaginary line 42 is illustrated slightly offset in an outboard direction from the exterior contour 40 of the front side door 24. The running board 30 is illustrated slightly offset from the imaginary line 42 in the inboard direction thereby providing a streamlined appearance of both the side doors 24, 26 and the running board 30. This streamlined appearance is illustrated in FIGS. 1 and 2.

Some vehicles, however, such as prior art vehicles, may include cladding or other ornamental accessories along a belt line of the vehicle. These accessories may extend laterally outward relative to the imaginary line 42. Accordingly, the invention contemplates that the running board 30 is oriented inboard of a lower region 44 of the door 24. The lower region 44 may be the region below the belt line of the vehicle. The lower region 44 may also be a region within six inches, measured vertically, from the running board platform 36.

Referring again to FIG. 4, the platform 36 is only partially accessible, if at all, in the closed orientation of the front side door 24. When closed, the door lower region 44 is disposed adjacent to the running board platform 36. Thus, the exterior aesthetics of the vehicle 10 are improved by generally concealing or blocking a portion of the running board 30.

The running board 30 is fixed to the vehicle body 12. Due to the arrangement of the running board 30 relative to the door frame 32, the running board 30 does not require a mechanism for extending and retracting the running board 30 while generally obtaining similar effects by partially covering the running board 30 with a lower portion 44 of each side door, such as front side door 24.

Referring again to FIG. 3, the front side door 24 provides access to the front row 20 of the passenger compartment 18 wherein a row of seats 45 are provided. A vehicle body pillar 46 is provided longitudinally rearward of the door frame 32 for separating the front side door frame 32 from a back side door frame 32. The back side door 26 may be pivotally connected to the pillar 46.

With respect to FIGS. 1 and 2, the running board 30 has a forward end 48 beginning proximate to a front quarter panel 50 of the vehicle 10. The running board 30 also has a rear end 52 terminating into a rear quarter panel 54 adjacent the bed 16 of the vehicle 10. Thus, the running board 30 is integrated into the front and rear quarter panels 50, 54 collectively providing a streamlined appearance.

The platform 36 extends lengthwise from forward end 48 to rearward end 52, displaced beneath the side doors 24, 26 to provide a uniform step and aesthetic appeal. Accordingly, the running board 30 is structurally supported by the vehicle body 12 to support a plurality of passengers thereon. Referring now to FIGS. 3 and 4, the structural arrangement of the running board 30, door frame 32 and front side door 24 is generally repeated for the rear side door 26. Therefore, the arrangements illustrated in FIGS. 1 through 4 are repeated for the left lateral side of the vehicle, which may also include a running board 30.

With respect to FIGS. 1-4, the platform includes traction 56 that is provided by a series of upraised generally rectangular traction pads 58. Each traction pad 58 has rounded corners for a softened visual transition along the running board 30. The traction pads 58 optimize both form and function by providing a stylized running board 30 with adequate traction for sound footing of the passenger.

With reference specifically to FIG. 3, an interior floor 60 of the passenger compartment 18 may also be provided with an array 62 of generally rectangular traction pads 64. The styling of the running board 30 is carried into the interior by a common traction design theme. The traction pads 64 also enhance traction to passengers when entering/exiting the vehicle or when resting their feet upon the interior floor 60 during travel.

Referring again to FIGS. 1 and 2, the stylized traction of the running board 30 and the interior floor 60 is repeated upon tires 66 of the vehicle as well. The tires 66 include a traction pattern 68 that incorporates generally rectangular traction pads 70 similar in appearance to the traction pads 58, 64 of the running board 30 and the interior floor 60. The traction pads 70 convey the common theme of styling while also providing traction to the underlying support surface upon which the vehicle 10 travels.

In summary, a passenger vehicle and running board are provided that optimize functionality, ergonomics and design appeal while minimizing complexities and difficulties associated with prior art running boards.

While embodiments for the present invention have been described in detail, those familiar with the art to which this invention relates will recognize various alternative designs and embodiments for practicing the invention as defined by the following claims.

What is claimed is:

1. A passenger vehicle comprising:
a vehicle body;
a passenger compartment provided within the vehicle body;
at least one door frame formed within the vehicle body providing a door aperture through the vehicle body for access to the passenger compartment;
at least one door operably connected to the door frame for translation relative to the door frame between a closed orientation for closing the door aperture and an open orientation for opening the door aperture; and
at least one running board mounted to the vehicle body, oriented substantially beneath the at least one door in the closed orientation of the door for supporting a foot of a passenger in the open orientation of the door while entering or exiting the passenger compartment.

2. The passenger vehicle of claim 1 wherein the running board is disposed at a height relative to the door frame such that a bottom portion of the door is oriented adjacent to the running board in the closed orientation of the door.

3. The passenger vehicle of claim 1 wherein the running board is oriented relative to the door frame to provide less than four inches of clearance therebetween.

4. The passenger vehicle of claim 1 wherein the at least one running board does not extend laterally outboard from the vehicle substantially greater than an exterior contour of the at least one door in the closed orientation.

5. The passenger vehicle of claim 1 wherein the at least one running board is disposed laterally inboard relative to a lower region of the door beneath a belt line of the vehicle.

6. The passenger vehicle of claim 1 wherein a lower region of the door is defined as being within six inches from the at least one running board, and the at least one running board is disposed laterally inboard relative to the lower region of the door.

7. The passenger vehicle of claim 1 wherein the at least one running board is provided partially beneath the at least one door frame.

8. The passenger vehicle of claim 1 wherein the at least one running board is fixed relative to the vehicle body.

9. The passenger vehicle of claim 1 wherein the at least one running board is at least partially inaccessible when the at least one door is in the closed orientation.

10. The passenger vehicle of claim 1 wherein the top surface of the at least one running board extends laterally inward and partially beneath the at least one door frame.

11. The passenger vehicle of claim 1 wherein the at least one running board is integrated into a front quarter panel and a rear quarter panel of the vehicle.

12. The passenger vehicle of claim 1 wherein the at least one running board has a generally planar top surface with a series of generally rectangular traction pads each extending therefrom.

13. The passenger vehicle of claim 12 further comprising an interior floor within the passenger compartment having an array of generally rectangular traction pads for enhancing footing of the passenger thereon and for providing a common styling theme with the running board.

14. The passenger vehicle of claim 12 further comprising a plurality of wheels for transporting the vehicle upon an underlying support surface wherein the wheels each have a tire traction pattern including an array of generally rectangular traction pads for enhancing traction of the vehicle upon the underlying support surface and for providing a common styling theme with the running board.

15. The passenger vehicle of claim 1 wherein the at least one door frame further comprises a first door frame and a second door frame each formed within the vehicle body on a lateral side thereof, the second door frame being adjacent to the first door frame.

16. The passenger vehicle of claim 15 further comprising a vehicle body pillar provided between the first door frame and the second door frame.

17. The passenger vehicle of claim 15 wherein the second door frame provides a second door aperture through the vehicle body for access to the passenger compartment.

18. The passenger vehicle of claim 17 wherein the at least one door further comprises a first door operably connected to the first door frame and a second door operably connected to the second door frame for translation of each door relative to the corresponding door frame between a closed orientation for closing the corresponding door aperture and an open orientation for opening the door aperture.

19. A running board for a motor vehicle comprising:
a first end adapted to be affixed to a vehicle body;
a second end adapted to be affixed to the vehicle body;
a platform extending between the first and second ends oriented to be displaced beneath a door of the motor vehicle generally proximate to a lower region of the door so that the platform is at least partially inaccessible in a closed orientation of the door, and the platform is accessible in an open orientation of the door for supporting a foot of a passenger while entering or exiting the passenger compartment.

20. A passenger vehicle comprising:
a vehicle body;
a passenger compartment provided within the vehicle body, the passenger compartment including an interior floor having an array of generally rectangular traction pads for enhancing footing of the passenger thereon;
at least one door frame formed within the vehicle body providing a door aperture through the vehicle body for access to the passenger compartment;
at least one door operably connected to the door frame for translation relative to the door frame between a closed orientation for closing the door aperture and an open orientation for opening the door aperture; and
at least one running board mounted to the vehicle body, oriented substantially beneath the at least one door in the closed orientation of the door for supporting a foot of a passenger in the open orientation of the door while entering or exiting the passenger compartment wherein the at least one running board has a generally planar top surface with a series of generally rectangular traction pads each extending at least partially above the running board top surface for enhancing footing of the passenger thereon and for providing a common styling theme with the running board.
